(19) United States
(12) Patent Application Publication
(10) Pub. No.: US 2012/0237697 A1
(43) Pub. Date: Sep. 20, 2012

(54) METHOD FOR SURFACE COATING CuBTC METAL-ORGANIC FRAMEWORK NANOSTRUCTURES ON NATURAL FIBERS

(75) Inventors: Amir Reza Abbasi, Tehran (IR); Ali Morsali, Tehran (IR)

(73) Assignees: Dr. Amir Reza Abbasi, Tehran (IR); TARBIAT MODARES UNIVERSITY, Tehran (IR); Dr. Ali Morsali, Tehran (IR)

(21) Appl. No.: 13/482,812

(22) Filed: May 29, 2012

Related U.S. Application Data
(60) Provisional application No. 61/491,208, filed on May 29, 2011.

(51) Int. Cl. B05D 7/00; B05D 3/02; B05D 1/18

(52) U.S. Cl. 427/601

(57) ABSTRACT

A method for the surface coating of CuBTC (Cu₃(BTC)₂, (BTC=1,3,5-benzenetricarboxylate; HKUST-1) Metal-Organic Framework (“MOF”) nanostructures on natural fibers is disclosed. The surface coating of CuBTC MOF nanostructures is achieved by sequential coating of the natural fibers with a copper precursor solution and a BTC precursor solution under ultrasound irradiation at ambient pressure and temperature. The results indicate a homogeneous coating of the CuBTC MOF nanostructures on the surface of the natural fibers with a narrow size distribution, which impart new properties on the final textile product, such as antimicrobial activity.

### CROSS-REFERENCE TO RELATED APPLICATIONS

The present application claims the benefit of U.S. Provisional Patent Application Ser. No. 61/491,208, filed May 29, 2011, which is incorporated herein by reference in its entirety.

### SPONSORSHIP STATEMENT This application has been financially sponsored for international filing by the Iranian Nanotechnology Initiative Council.

### TECHNICAL FIELD

This application generally relates to a method for integrating nanoparticles in textiles, and more particularly relates to a method for surface coating CuBTC metal-organic framework nanostructures on natural fibers.

### BACKGROUND

The development of new textiles based on the integration of nanoparticles in textile fibers has recently received growing interest. A wide range of nanoparticles with various structures can be integrated into the fibers, which creates new properties for the final textile product. These textiles can be used for hygienic clothing, wound healing, and medical applications in hospitals and other places where bacteria presents a hazard.

For example, Metal-Organic Framework (“MOF”) nanostructures have been deposited on synthetic textile fibers and other substrates, such as polymer surfaces, silica, porous alumina, graphite, and various metals, for the fabrication of functional materials for use in different applications, such as clothing and gas separation filters. To anchor the MOF nanostructures to the surfaces of the substrates, the surfaces of the substrates must be first be functionalized to form self-assembled monolayers (“SAMs”) before the MOF nanostructures are grown on the functionalized surfaces.

The step of functionalizing the surface of the substrates is costly and time consuming, however. Therefore, a new, more economical method for surface coating MOF nanostructures on natural fibers without the need for functionalizing the surface of the natural fibers is needed.

### SUMMARY

A method for surface coating CuBTC metal-organic framework nanostructures on natural fibers is disclosed. Initially, natural fibers including carboxyl groups on their surface are received. The natural fibers are immersed in an alkaline solution to form negatively charged natural fibers. The negatively charged natural fibers are then coated with a copper precursor solution under ultrasonic radiation to form copper ion coated natural fibers. Next, the copper ion coated natural fibers are coated with a 1,3,5-benzenetricarboxylate precursor under ultrasonic radiation to form CuBTC coated natural fibers. Finally, the CuBTC coated natural fibers are isolated.

In some implementations, the natural fibers are can be silk fibers and the alkaline solution can be potassium hydroxide solution. The pH of the alkaline solution can be between 10 and 13. The negatively charged natural fibers can be formed by deprotonating the carboxyl groups on the surface of the natural fibers. The negatively charged natural fibers can be immersed in the copper precursor solution and the copper ion coated natural fibers can be immersed in the 1,3,5-benzenetricarboxylate precursor solution.

In some implementations, the copper precursor solution can be copper(II) acetate hydrate and the 1,3,5-benzenetricarboxylate precursor solution can be 1,3,5-benzenetricarboxylic acid. The negatively charged natural fibers can be coated with the copper precursor solution at room temperature and at ambient pressure and the copper ion coated natural fibers can be coated with the 1,3,5-benzenetricarboxylate precursor solution at room temperature and at ambient pressure. The CuBTC coated natural fibers can be dried in a heated environment.

In some implementations, the copper ion coated natural fibers can be washed with distilled water to remove excess copper ions from the surface of the natural fibers and the CuBTC coated natural fibers can be washed with distilled water to remove excess CuBTC metal-organic framework nanostructures from the surface of the natural fibers.

In some implementations, the CuBTC coated natural fibers can be recoated with the copper precursor solution under ultrasonic radiation to form copper ion and CuBTC coated natural fibers and the copper ion and CuBTC coated natural fibers can be recoated with the 1,3,5-benzenetricarboxylate precursor solution under ultrasonic radiation to form more concentrated CuBTC coated natural fibers.

Another method for surface coating CuBTC metal-organic framework nanostructures on natural fibers is also disclosed. Initially, silk fibers including carboxyl groups on their surface are received. The silk fibers are immersed in an alkaline solution to form negatively charged silk fibers. The negatively charged silk fibers are then immersed in a potassium hydroxide solution under ultrasonic radiation at room temperature and at ambient pressure to form copper ion coated silk fibers. Next, the copper ion coated silk fibers are immersed in a 1,3,5-benzenetricarboxylic acid solution under ultrasonic radiation at room temperature and at ambient pressure to form CuBTC coated silk fibers. Finally, the CuBTC coated silk fibers are dried in a heated environment.

Details of one or more implementations and/or embodiments of the method for surface coating CuBTC metal-organic framework nanostructures on natural fibers are set forth in the accompanying drawings and the description below. Other aspects that can be implemented will be apparent from the description and drawings, and from the claims.

### BRIEF DESCRIPTION OF DRAWINGS

FIG. 1 illustrates an example of a method for surface coating CuBTC metal-organic framework nanostructures on natural fibers.

FIG. 2 illustrates a schematic representation of the coating of CuBTC MOF nanostructures on the surface of silk fibers.

FIG. 3 illustrates the solid state fluorescence spectra of pristine silk fibers and CuBTC coated silk fibers.

Like reference symbols indicate like elements throughout the specification and drawings.

### DETAILED DESCRIPTION

A method for the surface coating of CuBTC (Cu₃(BTC)₂, (BTC=1,3,5-benzenetricarboxylate; HKUST-1) Metal-Organic Framework (“MOF”) nanostructures on natural fibers is disclosed. The surface coating of CuBTC MOF nanostructures is achieved by sequential coating of the natural fibers with a copper precursor solution and a BTC precursor solution under ultrasound irradiation at ambient pressure and temperature. The results indicate a homogeneous coating of the CuBTC MOF nanostructures on the surface of the natural fibers with a narrow size distribution, which impart new properties on the final textile product, such as antimicrobial activity.

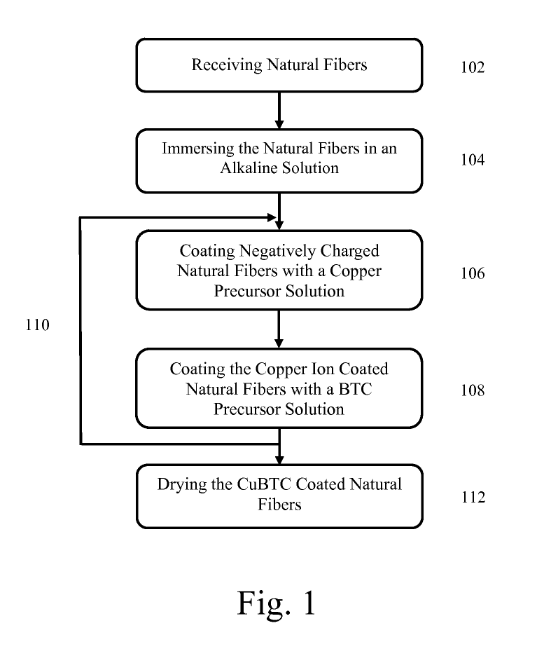

Referring to FIG. 1, a method for surface coating CuBTC MOF nanostructures on natural fibers is disclosed. Initially, natural fibers are received (step 102). In some implementations, the natural fibers can be any natural fibers that include carboxyl groups (—COOH) on their surface. The carboxyl groups on the surface of the natural fibers uptake metal cations by a chelation mechanism, resulting in high metal binding properties.

In some implementations, the natural fibers can be animal-based natural fibers, such as, for example, silk fibers, alpaca fibers, angora fibers, byssus fibers, camel fibers, cashmere fibers, catgut fibers, chiengora fibers, guanaco fibers, llama fibers, mohair fibers, pashmina fibers, qiviut fibers, rabbit fibers, sinew fibers, spider silk fibers, wool fibers, and/or yak fibers; vegetable-based fibers, such as, for example, bagasse fibers, bamboo fibers, coir fibers, cotton fibers, flax fibers, linen fibers, hemp fibers, jute fibers, kapok fibers, kenaf fibers, raffia fibers, ramie fibers, sisal fibers, and/or wood fibers; and mineral fibers, such as, for example, asbestos fibers. Preferably, in some implementations, the natural fibers can be silk fibers. Silk fibers are commonly used in biomedical applications because of their biocompatibility and minimal inflammatory response.

Next, the natural fibers are immersed in an alkaline solution to form negatively charged natural fibers (step 104). The alkaline solution can have a pH ranging from seven to 14 and, preferably, ranging from 10 to 13. In some implementations, the pH of the alkaline solution can be 10. The pH of the alkaline solution can be adjusted by increasing or decreasing the concentration of a base in the solution. In the alkaline pH, the surface of natural fibers becomes negatively charged due to the deprotonation of the carboxyl groups on the fibers' surface. As such, the electron pair on the carboxylic oxygen of the carboxyl groups on the fibers' surface is available for donation to metal ions, resulting in high metal binding properties.

In some implementations, the base can be any strong base, such as, for example, potassium hydroxide (KOH), barium hydroxide (Ba(OH)₂), caesium hydroxide (CsOH), sodium hydroxide (NaOH), strontium hydroxide (Sr(OH)₂), calcium hydroxide (Ca(OH)₂), lithium hydroxide (LiOH), and/or rubidium hydroxide (RbOH). Preferably, in some implementations, the base can be potassium hydroxide.

In some implementations, optionally, the negatively charged natural fibers can then be washed with a solution of distilled water to remove any excess alkaline solution from the surface of the natural fibers.

Next, the negatively charged natural fibers are coated with a copper precursor solution under ultrasonic radiation to coat copper ions (Cu²) onto the surface of the natural fibers to form copper ion coated natural fibers (step 106). In some implementations, the copper precursor solution can be copper(II) nitrate (Cu(NO₃)₂) and/or copper(II) acetate hydrate (“cupric acetate hydrate;” Cu(OAc)₂.2H₂O). Preferably, in some implementations, the copper precursor solution can be copper(II) acetate hydrate. In some implementations, the copper precursor solution can be mixed in an organic solution of dimethylformamide (“DMF;” (CH₃)₂NC(O)H) and ethanol (“EtOH;” CH₃CH₂OH).

In some implementations, the negatively charged natural fibers can be coated with the copper precursor solution by dipping or immersing the negatively charged natural fibers in the copper precursor solution so that copper ions are bound to the surface of the natural fibers via electrostatic interactions because the electron-rich oxygen atoms of the polar carboxyl groups on the surface of the negatively charged natural fibers interact with the electropositive copper ions. The negatively charged natural fibers can be coated with the copper precursor solution at room temperature of about 20° C. to 25° C. and ambient pressure of about one bar. The negatively charged natural fibers can be coated with the copper precursor solution for between one minute and ten minutes and, preferably, five minutes.

The ultrasonic radiation accelerates the chemical reaction between the surface of the negatively charged natural fibers and the copper ions without the need for increased pressure and temperature, resulting in a more economical synthesis of copper ion coated natural fibers. In particular, the ultrasonic radiation causes cavitations around the surface of the natural fibers and heating of the copper precursor solution. As the cavitations collapse near the surface of the natural fibers, the shock waves and microj ets cause effective mixing of the copper precursor solution, resulting in a more homogenous coating of the copper ions on the surface of the natural fibers.

In some implementations, optionally, the copper ion coated natural fibers can then be washed with a solution of distilled water to remove any excess copper ions not attached to the surface of the natural fibers.

Next, the copper ion coated natural fibers are coated with a BTC precursor solution under ultrasonic radiation to coat CuBTC MOF nanostructures onto the surface of the natural fibers to form CuBTC coated natural fibers (step 108). In some implementations, the BTC precursor solution can be 1,3,5-benzenetricarboxylic acid (H₃BTC). In some implementations, the BTC precursor solution can be mixed in an organic solution of dimethylformamide and ethanol.

In some implementations, the copper ion coated natural fibers can be coated with the BTC precursor solution by dipping or immersing the copper ion coated natural fibers in the BTC precursor solution so that the CuBTC MOF nanostructures are bound to the surface of the natural fibers. The copper ion coated natural fibers can be coated with the BTC precursor solution at room temperature of about 20° C. to 25° C. and ambient pressure of about one bar. The copper ion coated natural fibers can be coated with the BTC precursor solution for between one minute and ten minutes and, preferably, five minutes.

The ultrasonic radiation accelerates the chemical reaction between the copper ions on the surface of the natural fibers and the BTC to form CuBTC MOF nanostructures without the need for increased pressure and temperature, resulting in a more economical synthesis of CuBTC coated natural fibers. In particular, the ultrasonic radiation causes cavitations around the surface of the natural fibers and heating of the BTC precursor solution. As the cavitations collapse near the surface of the natural fibers, the shock waves and microj ets cause effective mixing of the BTC precursor solution, resulting in a more homogenous coating of the CuBTC MOF nanostructures on the surface of the natural fibers.

In some implementations, optionally, the CuBTC coated natural fibers can then be washed with a solution of distilled water to remove any excess CuBTC MOF nanostructures not attached to the surface of the natural fibers.

Optionally, in some implementations, the natural fibers can be cyclically coated with the copper precursor and the BTC precursor (step 110). Each CuBTC coating cycle consists of successively coating the natural fibers with the copper precursor and the BTC precursor. The negatively charged natural fibers can be coated with the CuBTC MOF nanostructures for multiple cycles, such as, for example, two to eight cycles. The different number of coating cycles results in different sizes and concentrations of CuBTC MOF nanostructure coated on the surface of the natural fibers, such that as the number of coating cycles is increased, the average size of the CuBTC MOF nanostructures and the concentration of the CuBTC MOF nanostructures are also increased.

Finally, the CuBTC coated natural fibers are dried (step 112). To isolate the CuBTC coated natural fibers, the CuBTC coated natural fibers can be dried at room temperature or, preferably, in a heated environment. The temperature of the heated environment can range from 40° C. to 100° C. and, preferably, can be 60° C. The CuBTC coated natural fibers can be dried for one hour to six hours until there is no water present in the natural fibers.

### CuBTC COATED SILK FIBERS EXAMPLES

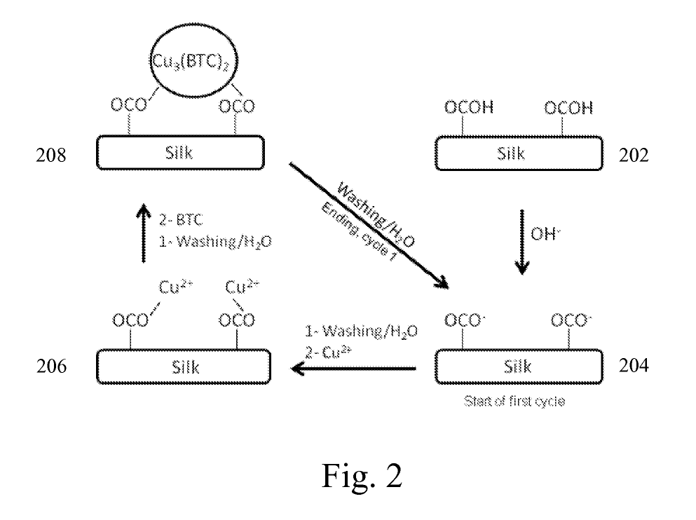

Referring to FIG. 2, a schematic representation of the coating of CuBTC MOF nanostructures on the surface of silk fibers is illustrated. Initially, pristine silk fibers 202 are received (corresponding to step 102). The pristine silk fibers 202 are then immersed in an alkaline solution of potassium hydroxide at a pH of either 10 or 13 (corresponding to step 104) to form negatively charged silk fibers 204. The negatively charged silk fibers 204 are then immersed in a solution of copper(II) acetate hydrate under ultrasonic radiation at room temperature and ambient pressure (corresponding to step 106) to form copper ion coated silk fibers 206. The copper ion coated silk fibers 206 are washed with distilled water to remove any copper ions not attached to the surface of the silk fibers. The copper ion coated silk fibers 206 are then immersed in a solution of 1,3,5-benzenetricarboxylic acid under ultrasonic radiation at room temperature and ambient pressure (corresponding to step 108) to form CuBTC coated silk fibers 208. The CuBTC coated silk fibers 208 are washed with distilled water to remove any CuBTC MOF nanostructures not attached to the surface of the silk fibers. The silk fibers can be coated with CuBTC MOF nanostructures for multiple cycles (corresponding to step 110). Finally, the CuBTC coated silk fibers 208 are dried at 60° C. (corresponding to step 112).

In order to determine the effects of ultrasonic radiation, immersion time, and pH on the concentration and size of the CuBTC MOF nanostructures on the silk fibers, multiple CuBTC coated silk fibers under different conditions are synthesized. In group I, the silk fibers are immersed in an alkaline solution at a pH of 10, then coated with the copper(II) acetate hydrate solution for one minute under ultrasound radiation, then washed with distilled water for two minutes, then immersed in the 1,3,5-benzenetricarboxylic acid solution for one minute under ultrasound radiation, then washed with distilled water for two minutes, and finally dried at 60° C. The coating with the copper(II) acetate hydrate solution, washing, coating with the 1,3,5-benzenetricarboxylic acid solution, and repeated washing, corresponding to a single cycle, can be repeated for two cycles, four cycles, six cycles, and eight cycles.

In group II, the CuBTC coated silk fibers are synthesized according to the same process used to synthesize the CuBTC coated silk fibers of group I, with the difference that the silk fibers are coated with the copper(II) acetate hydrate solution and the 1,3,5-benzenetricarboxylic acid solution for five minutes each rather than one minute each.

In group III, the CuBTC coated silk fibers are synthesized according to the same process used to synthesize the CuBTC coated silk fibers of group II, with the difference that ultrasonic radiation was not used to coat the silk fibers with the copper(II) acetate hydrate solution and the 1,3,5-benzenetricarboxylic acid.

In group IV, the CuBTC coated silk fibers are synthesized according to the same process used to synthesize the CuBTC coated silk fibers of group I, with the difference that the pristine silk fibers are immersed in an alkaline solution at a pH of 13 rather than a pH of 10.

The concentration, average particle size, and morphology of the CuBTC MOF nanostructures coated on the silk fibers group I-IV are summarized in TABLE 1, below. For each group, the coating with the copper(II) acetate hydrate solution and the 1,3,5-benzenetricarboxylic acid was repeated two, four, six, and eight times corresponding to two cycles, four cycles, six cycles, and eight cycles, respectively. An Inductively Coupled Plasma (“ICP”) measurement of the concentration of the CuBTC MOF nanostructures on the silk fibers was collected, the average diameter of the CuBTC MOF nanostructures was measured, and the morphology of the CuBTC MOF nanostructures as either a wire morphology, denoted by a “w,” or a particle morphology, denoted by a “p,” are provided In TABLE 1. The CuBTC MOF nanostructures are crystalline.

TABLE 1

| | | Two Cycle | | Four Cycle | | Six Cycle | | Eight Cycle |
|---|---|---|---|---|---|---|---|---|
| | Two | Average | Four | Average | Six | Average | Eight | Average |
| | Cycle ICP | Diameter | Cycle ICP | Diameter | Cycle ICP | Diameter | Cycle ICP | Diameter |
| Group | (ppm) | (nm) | (ppm) | (nm) | (ppm) | (nm) | (ppm) | (nm) |
| I | — | — | — | 70.7 _{w} | — | 107.7 _{w} | — | 247.1 _{w} |
| II | 20.45 | 182.1 _{w} | 45.85 | 254.6 ₚ | 49.21 | 343.3 | 288.40 | 431.2 _{w} |
| III | 3.14 | 187.5 _{w} | 21.10 | 844.6 _{w} | 64.51 | 104.8 ₚ | 304.52 | 224.3 _{w} |
| IV | — | 627 ₚ | — | 391 ₚ | — | >1000 _{w} | — | >1000 _{w} |

As indicated in TABLE 1, a greater number of cycles resulted in an increased concentration and average particle size of the CuBTC MOF nanostructures. By increasing the coating time from one minute in group Ito five minutes in group II, the average particle size of the CuBTC MOF nanostructures significantly increased. When ultrasonic radiation was not used in group III, the concentration of CuBTC MOF nanostructures was significantly lower when two and four cycles were used to coat the silk fibers relative to group II. When six and eight cycles were used to coat the silk fibers, the concentration of the CuBTC MOF nanostructures was slightly higher without ultrasonic radiation in group III. Finally, when the pH of the alkaline solution used to negatively charge the silk fibers is increased, the average particle size of the CuBTC MOF nanostructures coated on the silk fibers in group IV is significantly increased relative to group I. This result is due to the increased deprotonation of the carboxyl groups on the surface of the silk fibers, which leads to greater metal bonding of the copper ions.

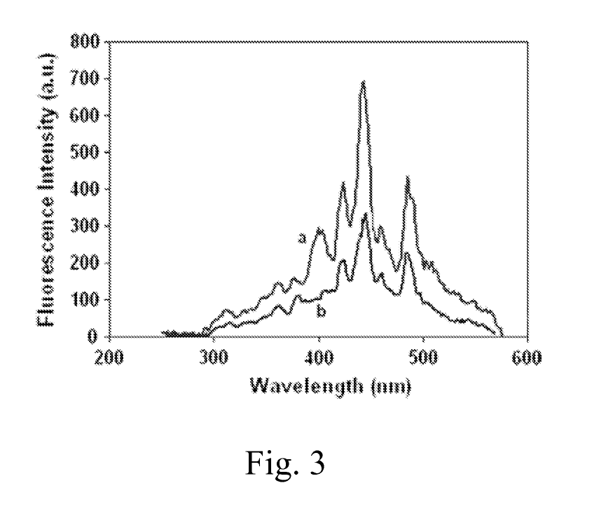

Referring to FIG. 3, the solid state fluorescence spectra of pristine silk fibers and CuBTC coated silk fibers prepared according to the group I example with eight cycles is illustrated. Pristine silk fibers, corresponding to line “a,” exhibit broad emission bands between 300 nm and 580 nm, with maximum intensities at 400 nm, 424 nm, 444 nm, and 485 nm upon excitation at 200 nm. The CuBTC coated silk fibers prepared according to the group II example with eight cycles, corresponding to line “b,” exhibits similar emission bands with reduced in emission intensities. The reduction in emission intensities is due to the formation of coordination bonds between the negatively charged carboxyl groups on the surface of the silk fibers and the copper ions which are electrostatically attached to the carboxyl groups.

The antibacterial activity of the CuBTC coated silk fibers was evaluated against Escherichia coli, a gram-negative bacterium, and Staphylococcus aureus, a gram-positive bacterium. A mixture of nutrient broth and nutrient agar was cast into Petri dishes and cooled. Approximately 10 colony-forming units of each bacterium were inoculated on each dish and then disks including gentamicin and various samples of CuBTC coated silk fibers were planted onto the dishes. All of the dishes were incubated at 37° C. for 24 hours and, following incubation, the diameter of inhibition was measured. The average diameters of inhibition for the gentamicin and various CuBTC coated silk fibers are provided in TABLE 2, below.

TABLE 2

| | Zone Diameter | Zone Diameter |
|---|---|---|
| | Against E. Coli | Against S. Aureus |
| Compound | (mm) | (mm) |
| Gentamicin | 10 | 27 |
| Group III, Eight | 7.5 | No Inhibition |
| Cycle | | |
| Group IV, Four | 7.7 | 6.5 |
| Cycle | | |

As indicated in TABLE 2, the CuBTC coated silk fibers were more effective against gram-positive and gram-negative bacterium than gentamicin. The antibacterial activity of the CuBTC coated silk fibers is mainly due to the release of the active phase, i.e., the copper ions and the CuBTC MOF nanostructures, into the surrounding medium.

The CuBTC coated natural fibers can be used in various applications, such as, for example, antibacterial textiles, separation membranes, such as gas separation membranes, artificial tissues, scaffolds, catalysts, and/or gas storage containers.

It is to be understood that the disclosed implementations are not limited to the particular processes, devices, and/or apparatus described which may, of course, vary. It is also to be understood that the terminology used herein is for the purpose of describing particular embodiments only, and is not intended to be limiting. As used in this application, the singular forms “a,” “an,” and “the” include plural referents unless the content clearly indicates otherwise.

Reference in the specification to “one implementation” or “an implementation” means that a particular feature, structure, characteristic, or function described in connection with the implementation is included in at least one implementation herein. The appearances of the phrase “in some implementations” in the specification do not necessarily all refer to the same implementation.

Accordingly, other embodiments and/or implementations are within the scope of this application.

What is claimed is:

1. A method for surface coating CuBTC metal-organic framework nanostructures on natural fibers, comprising:
receiving natural fibers, wherein the natural fibers include carboxyl groups on their surface;
immersing the natural fibers in an alkaline solution to form negatively charged natural fibers;
coating the negatively charged natural fibers with a copper precursor solution under ultrasonic radiation to form copper ion coated natural fibers;
coating the copper ion coated natural fibers with a 1,3,5-benzenetricarboxylate precursor solution under ultrasonic radiation to form CuBTC coated natural fibers; and
isolating the CuBTC coated natural fibers.

2. The method of claim 1, wherein receiving the natural fibers comprises receiving silk fibers.

3. The method of claim 1, wherein immersing the natural fibers in the alkaline solution comprises immersing the natural fibers in a solution of potassium hydroxide.

4. The method of claim 1, wherein the pH of the alkaline solution is between 10 and 13.

5. The method of claim 1, wherein the negatively charged natural fibers are formed by deprotonating the carboxyl groups on the surface of the natural fibers.

6. The method of claim 1, wherein:
coating the negatively charged natural fibers with the copper precursor solution under ultrasonic radiation to form the copper ion coated natural fibers comprises immersing the negatively charged natural fibers with the copper precursor solution under ultrasonic radiation to form the copper ion coated natural fibers, and
coating the copper ion coated natural fibers with the 1,3,5-benzenetricarboxylate precursor solution under ultrasonic radiation to form the CuBTC coated natural fibers comprises immersing the copper ion coated natural fibers with the 1,3,5-benzenetricarboxylate precursor solution under ultrasonic radiation to form the CuBTC coated natural fibers.

7. The method of claim 1, wherein the copper precursor solution is copper(II) acetate hydrate.

8. The method of claim 1, wherein the 1,3,5-benzenetricarboxylate precursor solution is 1,3,5-benzenetricarboxylic acid.

9. The method of claim 1, wherein:
coating the negatively charged natural fibers with the copper precursor solution under ultrasonic radiation to form the copper ion coated natural fibers comprises coating the negatively charged natural fibers with the copper precursor solution under ultrasonic radiation at room temperature and at ambient pressure to form the copper ion coated natural fibers, and
coating the copper ion coated natural fibers with the 1,3,5-benzenetricarboxylate precursor solution under ultrasonic radiation to form the CuBTC coated natural fibers comprises coating the copper ion coated natural fibers with the 1,3,5-benzenetricarboxylate precursor solution under ultrasonic radiation at room temperature and at ambient pressure to form the CuBTC coated natural fibers.

10. The method of claim 1, wherein isolating the CuBTC coated natural fibers comprises drying the CuBTC coated natural fibers in a heated environment.

11. The method of claim 1, further comprising:
washing the copper ion coated natural fibers with distilled water to remove excess copper ions from the surface of the natural fibers, and
washing the CuBTC coated natural fibers with distilled water to remove excess CuBTC metal-organic framework nanostructures from the surface of the natural fibers.

12. The method of claim 1, further comprising:
recoating the CuBTC coated natural fibers with the copper precursor solution under ultrasonic radiation to form copper ion and CuBTC coated natural fibers, and
recoating the copper ion and CuBTC coated natural fibers with the 1,3,5-benzenetricarboxylate precursor solution under ultrasonic radiation to form more concentrated CuBTC coated natural fibers.

13. A method for surface coating CuBTC metal-organic framework nanostructures on natural fibers, comprising:
receiving silk fibers including carboxyl groups on their surface;
immersing the silk fibers in an alkaline solution to form negatively charged silk fibers;
immersing the negatively charged silk fibers in a potassium hydroxide solution under ultrasonic radiation at room temperature and at ambient pressure to form copper ion coated silk fibers;
immersing the copper ion coated silk fibers in a 1,3,5-benzenetricarboxylic acid solution under ultrasonic radiation at room temperature and at ambient pressure to form CuBTC coated silk fibers; and
drying the CuBTC coated silk fibers in a heated environment.
